(19) United States
(12) Patent Application Publication
(10) Pub. No.: US 2019/0394512 A1
(43) Pub. Date: Dec. 26, 2019

(54) Low Latency Video Streaming Via a Distributed Key-Value Store

(71) Applicant: Verizon Digital Media Services Inc., Dulles, VA (US)

(72) Inventors: David Andrews, Los Angeles, CA (US); Derek Shiell, Santa Monica, CA (US)

(21) Appl. No.: 16/017,717

(22) Filed: Jun. 25, 2018

(51) Int. Cl. H04N 21/266; H04N 21/643; H04L 29/08; H04N 21/235

(52) U.S. Cl. CPC H04N 21/26613; H04N 21/235; H04L 67/2842; H04N 21/643

(57) ABSTRACT

Systems and methods provide low latency video streaming from a delivery platform via a distributed key-value store. The distributed key-value store is implemented by enhancing distribution devices of the delivery platform with a reflector. The reflector may detect publish messages for entering data into the distributed key-value store. The reflector may generate and issue a first message to cause a distribution device to enter a retrieval state/mode based on the first message specifying a request for the key-value of the publish message, and the request resulting in a cache miss at the distribution device. The reflector may also generate and issue a second message to cause the distribution device to store the key-value from the publish message in the key-value store. The second message may be a response to the first message request, and may include data from the key-value of the publish message.

### BACKGROUND ART

Live video that is streamed over a digital network (e.g., the Internet), may be delayed relative to a broadcast feed (e.g., over-the-air or via cable) of the same live video. The delay may be due to the delivery platform infrastructure, and the latency associated with publishing the stream segments that encode the live video to the delivery platform, and propagating the stream segments to the distribution nodes of the delivery platform where the live video stream can then be distributed to client devices.

FIG. 1 provides an example architecture of delivery platform 100 to illustrate the delay associated with streaming live video. Delivery platform 100 includes different distribution points-of-presence (PoPs) 110 and 120 that are located in different geographic regions, one or more origin PoPs 130, and one or more ingest points 140.

Data originator 150 publishes (at 1) a live video stream to ingest point 140. This may include uploading encoded and/or transcoded segments of the live video via an encoder or transcoder to ingest point 140. A segment may include images and/or audio for some short section of the live video. For instance, each segment may represent a different three second section of the live video that is encoded to a different transport stream file. Data originator 150 uploads (at 1) a segment to ingest point 140 after the images and/or audio content for that segment are generated and encoded/transcoded to a file (e.g., a transport stream file). In comparison, a broadcast feed may distribute the images and/or audio to client devices as the images and/or audio content are generated. The encoding of the live video into segments, and the subsequent publishing of the segments to delivery platform 100 therefore account for a first part of the delayed distribution of the live video stream relative to the broadcast feed.

A second part of the delayed distribution is due to the propagation of the published segments from delivery platform ingest point 140 to distribution PoPs 110 and 120. Once a segment is published (at 1) to ingest point 140, ingest point 140 can announce (at 2) the availability of the segment to origin PoPs 130. Client device requests for the segment that arrive at the delivery platform 100, and more specifically, at distribution PoPs 110 and 120 of delivery platform 100, before the announcement is issued from ingest point 130, may result in an unavailable or other error. The error may result because distributions PoPs 110 and 120 and/or origin PoP 130 have no information as to where the requested segments may be obtained. Initial requests that arrive (at 3) at distribution PoPs 110 and 120 after the announcement is issued from ingest point 130 result (at 4) in cache misses at distribution devices of distribution PoPs 110 and 120. The cache misses result from the distribution devices of PoPs 110 and 120 not having a local copy of the requested segment stored to local cache storage. In response to a cache miss, a distribution device may request (at 5) the segment from origin PoP 130.

Initial requests for the segment that arrive at origin PoP 130 also result (at 6) in a cache miss. In response to a cache miss, origin PoP 130 may request (at 7) and retrieve (at 8) a copy of the requested segment from ingest point 140 based on the announcement of the stream segment availability from ingest point 140. Origin PoP 130 may also cache a copy of the retrieved segment(s). Origin PoP 140 may forward (at 9) the segment to the requesting distribution device in distribution PoP 110 or 120, and that distribution device can then redistribute (at 10) the segment from the corresponding distribution PoP 110 or 120 to a requesting client device. The distribution device may also locally cache a copy of the segment so that subsequent requests for that segment can be served from the corresponding distribution PoP 110 or 120 without another retrieval from origin PoP 130. Each cache miss and each retrieval of the segment results in some time delay (e.g., tens or hundreds of milliseconds). The delays combined with the delays associated with publishing the segment to delivery platform 100 and the delivery of the segment from distribution devices in distribution PoPs 110 and 120 to the requesting client devices cause the live video stream to be delayed by several seconds relative to the broadcast feed.

### BRIEF DESCRIPTION OF THE DRAWINGS

FIG. 1 provide an example architecture for a delivery platform to illustrate the delays associated with streaming live video.

FIG. 2 illustrates an example of low latency video streaming via the distributed key-value store.

FIG. 3 illustrates an example of using the distributed key-value store to facilitate low latency streaming of a live media stream from other distribution PoPs or distribution devices of the delivery platform.

FIG. 4 illustrates a modified delivery platform architecture for the distributed key-value store.

FIG. 5 presents a process for providing the key-value store capabilities to a particular distribution device in accordance with some embodiments.

FIG. 6 illustrates an example of the message generation performed by the reflector in accordance with some embodiments.

FIG. 7 illustrates an example of storing security and/or encryption parameters that were negotiated when establishing a secure connection between a client device and a first distribution device in a key-value store, and reusing the security and/or encryption parameters from the key-value store for a secure connection between the client device and a different second distribution device without reestablishing the secure connection, or renegotiating the security and/or encryption parameters for the secure connection.

FIG. 8 illustrates a computer system or server with which some embodiments are implemented.

### DETAILED DESCRIPTION

Systems and methods provide low latency video streaming by adapting a delivery platform as a distributed key-value store. The distributed key-value store is provided at the network edges of the delivery platform by two or more distribution devices of the delivery platform. The two or more distribution devices receive client device requests, distribute content to the client devices in response to the requests, and provide the distributed key-value store by directly ingesting data at the delivery platform edge, and by making that data immediately accessible to the client devices, data originators, and other distribution devices of the delivery platform.

Using the distributed key-value store, data originators may publish data, including live video stream data, directly to the delivery platform network edge via any of the distribution devices, and the distribution devices may immediately redistribute the published data from the network edge to the client devices. More specifically, data originators may publish the live video stream data directly to distribution devices that are closest to the geographic regions where the live video is to be primarily served.

Propagation delay can be significantly reduced, because the live video stream data is published to the same device (e.g., the distribution device) that redistributes the live video data to requesting client devices. Publishing delay can further be reduced, because the distribution device can immediately redistribute the raw data of a live video stream segment as the data is received (e.g., published to the distribution device on a packet-by-packet or byte-by-byte basis), rather than delay distribution until an entire segment (e.g., comprised of multiple packets) is published to the delivery platform, and an announcement is made that the segment is available for redistribution. The publishing of raw data to a distribution device, as well as the immediate redistribution of that raw data from the distribution device to requesting client devices provide live video streaming with similar delays as a broadcast feed of the same live video, and with significantly less delay than live video streaming provided by other delivery platforms that separate the point of ingest from the point of delivery.

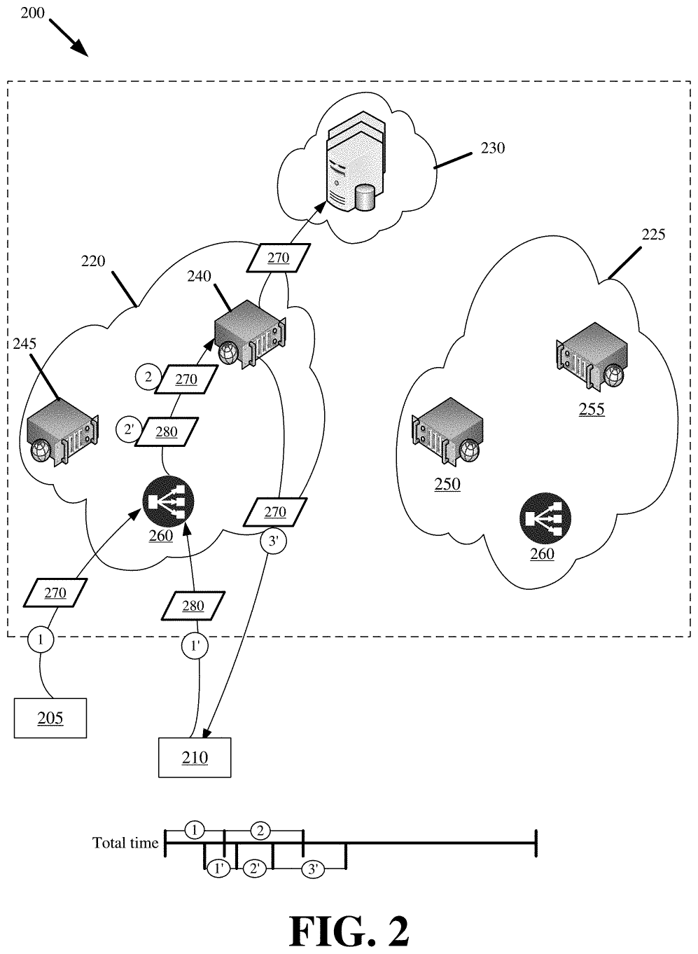

FIG. 2 illustrates an example of low latency video streaming via the distributed key-value store. The figure illustrates delivery platform 200, data originator 205, and one or more client devices 210.

Delivery platform 200 has two or more distribution points-of-presence (PoPs) 220 and 225 and at least one origin PoP 230. Distribution PoPs 220 and 225 are located next to different geographic regions and client devices operating from those geographic regions. Each distribution PoP 220 and 225 includes one or more distribution devices (e.g., 240, 245, 250, and 255) and at least one director 260.

The distribution devices (e.g., 240, 245, 250, and 255) may include caching servers with local storage (e.g., memory, disk, or other storage). The local storage of a particular distribution device may be used to cache content that is requested and served from that particular distribution device. Cached content may include data or files that a distribution device obtains from origin PoP 230, another distribution device, or directly from data originator 205 or client device 210 (via usage of the distributed key-value store), that the distribution device temporarily stores to the local storage, and/or that the distribution device redistributes to client devices 210. The cached content can be any data, including raw data (e.g., bytes of a media segment) or segments (e.g., transport segment files) of different media streams, wherein a media stream can include video, audio, text, games, or other digital content that spans and changes over a duration.

In FIG. 2, data originator 205 may issue (at 1) message 270 to publish data associated with a live media stream to delivery platform 200. Domain Name System (DNS), Anycast, or other routing mechanism may route message 270 to the nearest distribution PoP. In this example, the nearest distribution PoP is distribution PoP 220. In some embodiments, data originator 205 may publish the data associated with the live media stream to one or more distribution PoPs (e.g., 220 or 225) of data originator's 205 choosing by issuing message 270 to specific addressing associated with the chosen distribution PoPs.

Director 260 at distribution PoP 220 may receive message 270, and may determine where to forward message 270 within distribution PoP 220. The director 260 may hash a Uniform Resource Locator (URL) and/or cache key associated with message 270, and identify distribution device 240 based on the hash result. The director 260 may forward (at 2) the message with the live media stream data from data originator 205 to distribution device 240, thereby allowing data originator 205 to publish the live media stream data directly to the key-value store of distribution device 240.

Distribution device 240 enters the live media stream data to its key-value store as the data is published by data originator 205. The key-value store may represent a portion of distribution device's 240 local storage that is reserved or used for storing key-value data. Distribution device 240 may also send the live media stream data to origin PoP 230 where a secondary copy may be also cached.

Contemporaneous with issuance of message 270, client devices 210, operating in geographic regions neighboring distribution PoP 220, may submit (at 1′) requests 280 for the live media stream to distribution PoP 220. Once again, DNS, Anycast, or other routing mechanism may route the requests from client devices 210 to director 260 of distribution PoP 220. Director 260 hashes the URL from each request in order to determine which distribution device within distribution PoP 220 is tasked with distribution of the live media stream. The hash may provide a persistent identification of distribution device 240. Accordingly, director 260 may pass (at 2′) requests 280 to distribution device 240.

Distribution device 240 can immediately respond to requests 280 for the live media stream data as a result of the live media stream data being published to and entered to the key-value store of distribution device 240. Specifically, client device 210 may request a particular segment of the live media stream from distribution device 240 as data for that particular segment is being published with message 270 by data originator 205 to distribution device 240. Distribution device 240 may redistribute (at 3′) the particular segment data (e.g., data from message 270) to client device 210 as distribution device 240 receives the particular segment data from data originator 205. For instance, the request URL from client device 210 may hash to a key-value that is being actively being written to, and that already contains some amount of data. Rather than wait for the writing to end (e.g., wait for an entire segment to be received), distribution device 240 may begin providing (at 3′) the data for the key-value that has already been received to client device 210.

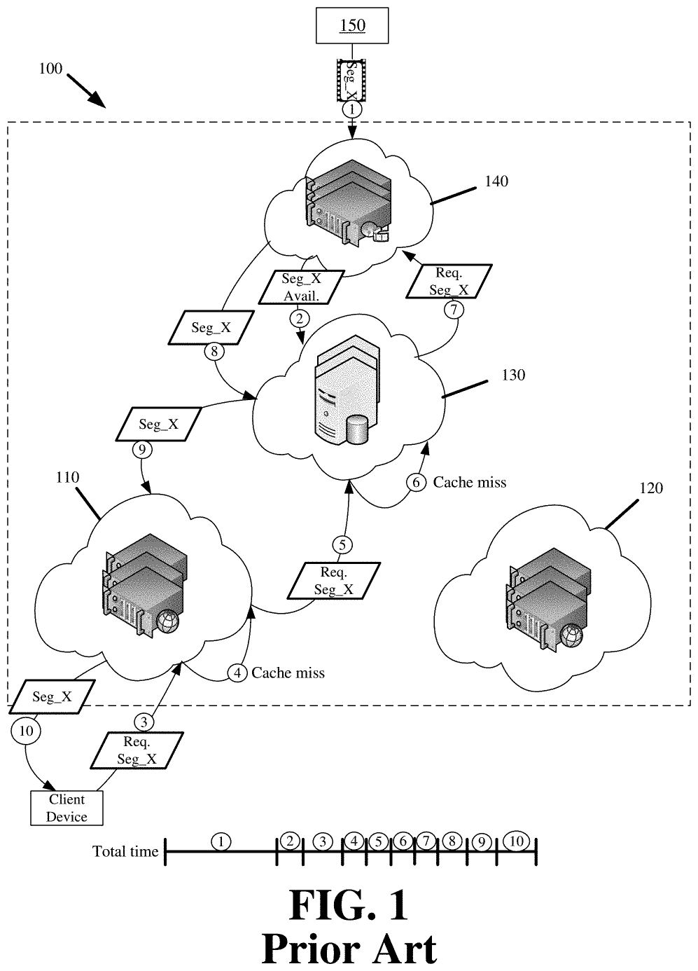

The total time and delay for distributing a particular stream via a delivery platform with the distributed key-value store is illustrated by FIG. 2. The total time and delay for distributing the same particular stream via a delivery platform without the distributed key-value store is illustrated by FIG. 1. As can be seen, the delivery platform with the distributed key-value store can distribute the particular stream in significantly less time and with significantly less latency than the delivery platform without the distributed key-value store.

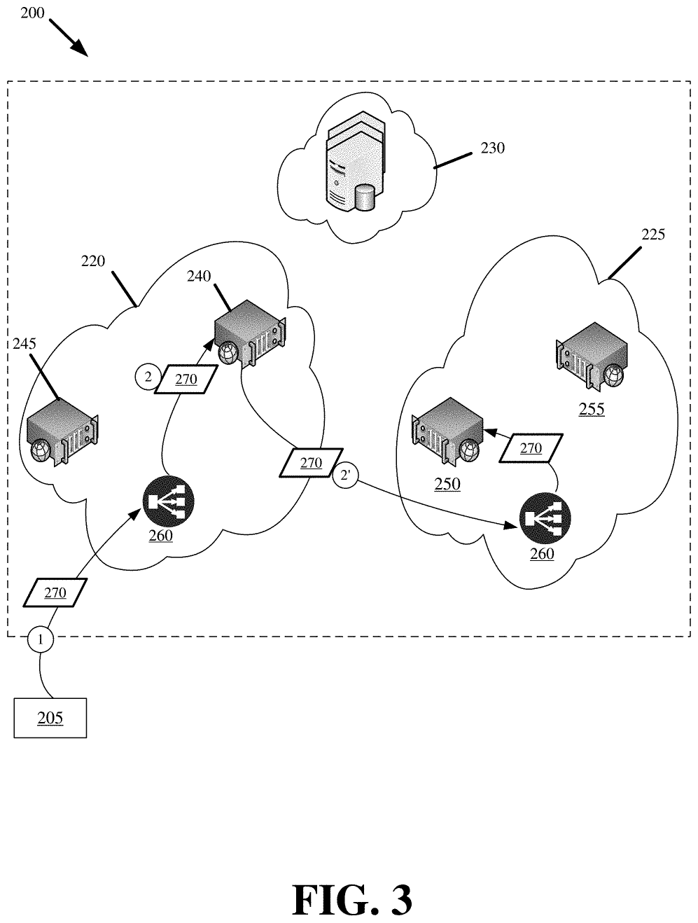

FIG. 3 illustrates an example of using the distributed key-value store to facilitate low latency streaming of a live media stream from other distribution PoPs or distribution devices of the delivery platform. The operations illustrated in FIG. 3 may be performed contemporaneously or simultaneously with the operations illustrated in FIG. 2.

FIG. 3 illustrates distribution device 240 in distribution PoP 220 performing a peer cache fill operation, whereby distribution device 240 provides a copy of the live media stream data to distribution device 250 in distribution PoP 225 of delivery platform 200. Distribution device 240 may perform the peer cache fill operation as distribution device 240 receives the live media stream data from data originator 205, or sometime thereafter.

Distribution device 240 may initiate the peer cache fill operation in response to data originator 205 publishing the live media stream data to the key-value store of distribution device 240. In other words, distribution device 240 may initiate the peer cache fill operation without receiving a request for the live media stream data from distribution device 250 or another device. Distribution device 240 may condition performing the peer cache fill operation on parameters or settings associated with the live media stream. The parameters or settings may be published as separate key-value pairs, may be included in metadata of the live media stream data, or may be determined by the delivery platform 200 based on demand or other metrics. The parameters or settings may identify the live media stream as a popular stream, or one that is to be streamed globally or from all distribution PoPs 220 and 225 of delivery platform 200. For example, the live media stream may be a stream of a popular sporting event, and is therefore expected to be watched by millions of viewers from across the world. In this example, distribution device 240 may immediately initiate the peer cache fill operation to expediate the propagation of the live media stream data across the delivery platform 200.

Distribution device 240 may perform the peer cache filling by publishing the live media stream data directly to the key-value store of distribution device 250, in a similar manner as data originator 205 publishes the live media stream data to the key-value store of distribution device 240. For instance, distribution device 240 may issue its own publish message, similar to the one issued by data originator 205, to distribution device 250 or to distribution PoP 225 (e.g., director 260 operating in distribution PoP 225).

In the event that the peer cache fill operation is not performed, distribution device 250 may still retrieve the live media stream data from origin PoP 230. Origin PoP 230 may be the default location from which distribution devices of one or more distribution PoPs (e.g., PoPs 220 and/or 225) obtain specific content (e.g., the live media stream from data originator 205) in response to requests for that specific content that result in cache misses at the distribution devices. Alternatively, distribution device 250 may hash an identifier (e.g., URL) from a request for a segment of the live media stream. The hash result may direct distribution device 250 to origin PoP 230, and distribution device 250 may retrieve the segment from origin PoP 230 after streaming device 240 publishes the live media stream data corresponding to the segment to origin PoP 230.

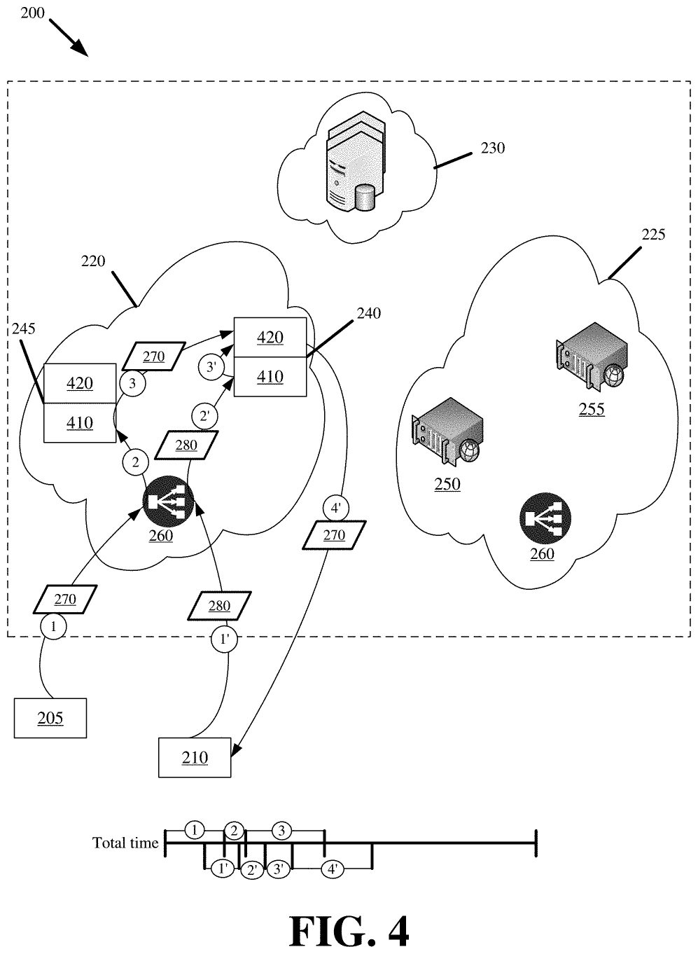

FIG. 4 illustrates a modified delivery platform architecture for the distributed key-value store. In this figure, operation of each distribution device 240 and 245 in distribution PoP 220 may be logically divided into front-end node 410 and back-end node 420.

Front-end node 410 may perform a message distribution function similar or different to that of director 260 from FIG. 2. For instance, front-end node 410 may provide a persistent distribution of messages across back-end nodes 420 of a particular distribution PoP, including a persistent distribution of publish messages directed to the same keys or key-values, as well as request messages for the same keys or key-values. Consequently, the distributed key-value store may store one copy of each key-value pair, and each distribution device 240 or 245 in the distribution PoP 220 may access that copy regardless of which back-end node 420 the key-value pair is stored to. Front-end node 410 may hash a URL and/or cache key associated with a message to identify which back-end node 420 of the different distribution devices in the particular distribution PoP is to receive the message. In FIG. 4, director 260 may perform a simplistic distribution (e.g., round robin distribution) of messages across front-end nodes 410, with front-end nodes 410 determining (e.g., based on a URL and/or cache key hash) and persistently routing the messages to a proper back-end node 420.

Back-end node 420 may perform the server and/or caching logic for a distribution device. Back-end node 420 may manage local storage of the corresponding distribution device by entering and removing retrieved content and/or key-values into the local storage of the corresponding distribution device.

Accordingly, when data originator 205 issues (at 1) publish message 270 in FIG. 4, publish message 270 may be received by director 260 in distribution PoP 220. Director 260 may perform a simplistic distribution (at 2) of publish message 270 to front-end node 410 executing on first distribution device 245. Front-end node 410 hashes an identifier (e.g., URL and/or cache key) associated with publish message 270 to determine which back-end node 420 of which distribution device 240 or 245 in distribution PoP 220 is tasked with responding to publish message 270. In this figure, front-end node 410, executing on first distribution device 245, passes (at 3) publish message 270 to back-end node 420, executing on second distribution device 240. Back-end node 420, executing on second distribution device 240, may enter the data from the key-value of publish message 270 into local storage. In this example, the data may be data for a live media stream.

Client device 210 may issue (at 1′) request 280 for the live media stream data contemporaneous with data originator 205 publishing the data to the distributed key-value store. Request 280 first arrives (at 1′) at director 260. Director 260 may perform a simplistic distribution, and may distribute (at 2′) request 280 to front-end node 410 of second distribution device 240. Front-end node 410 determines that request 280 is for data that is served from back-end node 410 on second distribution device 240. Accordingly, front-end node 410 passes (at 3′) request 280 to back-end node 410 of distribution device 240, and back-end node 410 responds to the request by serving (at 4′) the data from the key-value store. Thus, even though publish message 270 and request message 280 were initially directed to different distribution devices 240 and 245, front-end node 410 operation ensures that the messages (e.g., 270 and 280) accessed the same key-value store and were processed by back-end node 420 of distribution device 240.

The key-value store may be implemented by adding a reflector to each distribution device of the delivery platform that provides the key-value store capabilities. The reflector may be added to execute in conjunction with either the front-end node or the back-end node of the distribution device. The reflector may be a software or hardware module or component that is added to enhance the distribution device, and to provide the key-value store capabilities at the distribution device.

The reflector works in conjunction with existing caching and content distribution logic of the distribution devices, and/or the logical operations of the front-end node and back-end node of the distribution devices. In other words, the reflector may add the key-value store capabilities to a distribution device without changing or modifying existing functionality of the distribution device.

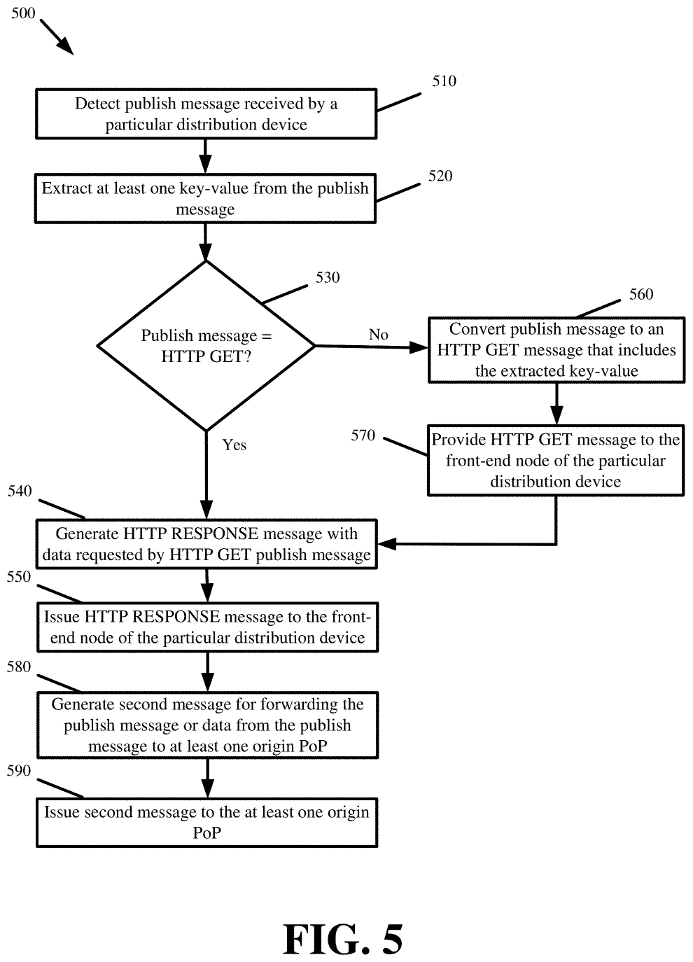

FIG. 5 presents a process 500 for providing the key-value store capabilities to a particular distribution device in accordance with some embodiments. Process 500 may be performed by a reflector that executes on or in conjunction with the particular distribution device.

Process 500 commences in response to the reflector detecting (at 510) a publish message that is received by the particular distribution device. The reflector may detect the publish message as a message that includes at least one key-value pair. The key may be some arbitrary identifying string. The value is the data for the key.

Request and other messages may be differentiated from a publish message based on the presence or absence of the key-value. For instance, requests and other messages may contain a URL that includes or is representative of a key, but omit an associated value or data for the key. As a more specific example, a publish message and a request message may both be HyperText Transfer Protocol (HTTP) GET messages. The HTTP GET messages may be differentiated based on the publish GET message including a key and data for the key somewhere in the message URL, header, and/or body. The publish message may also be differentiated from other messages based on other identifiers, URL tokens, or header fields. In some embodiments, the publish message may be differentiated by message type or format. For instance, the publish message may be an HTTP POST message or an HTTP PUT message, whereas other messages may be HTTP GET messages, other HTTP message types, or messages of different communication protocols (e.g., HTTP Secure (HTTPS), File Transfer Protocol (FTP), Remote Procedure Call (RPC), and other application layer or transport layer protocols).

The key-value may be provided in a URL, header, or body of the publish message. Query strings may be used to provide the key-value with the URL. The key-value example of “˜/streamXYZ.segment1=AVZXEDRWQ12ADSF” specifies a key identifying a segment of a particular stream (e.g., “˜/streamXYZ.stream1”) and data for the identified segment (“AVZXEDRWQ12ADSF”), wherein the data may contain encoded or transcoded media content (e.g., images and/or audio) for some duration of the particular stream. Data for the key-value may be encoded using one or more encoding schemes. When the key-value is provided as a query string, the URL or message header may contain an identifier to specify the message as a publish message rather than a request message with query string arguments. Example URL “˜/publish/XCWDS/streamXYZ.segment1=” may have a “publish” identifier, followed by an authentication token “XCWDS”, followed by the key-value. The key-value may be provided in an extended header field in the header of an HTTP message or other message. Data of any size may be placed in the publish message body by encapsulating the publish message as one or more packets. In some embodiments, the key and value may be split with the key being provided in one of the URL, header, or body of the publish message, and the value being provided in another of the URL, header, or body of the publish message.

Multiple key-values can be provided with a publish message. The one or more key-values can be inserted as one or more query string arguments that are appended or otherwise passed with a URL of the publish message. Example URL “˜/path?param1=value1&param2=value2&param3=value3” includes three key-value pairs. The multiple key-values can also be provided via multiple extended headers in the header of the publish message, or delimited in the body of the publish message via an identifier, symbol, or other indicator.

The publish message may be authenticated before being acted upon by the reflector or the particular distribution device. For instance, the particular distribution device may accept publish messages from data originators that are authorized to publish data using the key-values. The data originators may provide a token with the data publish message or provide other forms of authentication prior to or in conjunction with sending the data publish message. For instance, a publish message may require a URL that includes a unique data originator identifier and/or an authentication value.

The reflector may detect (at 510) the publish message based on configured access to the network protocol stack of the particular distribution device, or by listening on the network interface of the particular distribution device. For instance, the reflector can bind to the Internet Protocol (IP) assigned to the network interface of the particular distribution device, or to the 0.0.0.0 address for all network interfaces of the particular distribution device. The reflector can also be configured to listen on a specific port (e.g., 80 or 8080), or listen for specific traffic. For instance, the reflector may detect publish messages from messages that the particular distribution device sends in response to a cache miss. This may include messages that the particular distribution device sends to an origin PoP or other destination in response to receiving an HTTP GET message for content or a key-value pair that is not locally cached at the particular distribution device.

In response to detecting the publish message, the reflector extracts (at 520) at least one key-value from the publish message. The reflector may extract the at least one key-value from any of the URL, header, or body of the publish message.

The reflector may determine (at 530) a format of the publish message. For instance, the reflector may determine if the publish message is issued as an HTTP POST, HTTP GET, or other message format or type.

In response to determining (at 530) that the publish message is formatted as an HTTP GET message, the reflector may generate (at 540) a response message to the HTTP GET message. The response message may provide the data requested by the HTTP GET message, wherein the data is copied from the value of the key-value that was extracted (at 520) from the publish message. For instance, the response message may be an HTTP RESPONSE message. The HTTP RESPONSE message may include a 200 (OK) response status code and the data from the value of the extracted key-value. The HTTP RESPONSE message may further include a cache key that specifies an identifier for identifying and/or requesting the data from the value of the extracted key-value. The cache key identifier may be the key of the extracted key-value or a URL. The URL can be the URL from the publish message appended or otherwise modified with the key of the extracted key-value. The data may be inserted in a body of the HTTP RESPONSE message, in a header of the HTTP RESPONSE message, or as a query string that is associated with the URL of the HTTP RESPONSE message

The reflector may issue (at 550) the response message to the front-end node of the particular distribution device. For instance, the reflector may issue the response message to the localhost of the particular distribution device (e.g., IP address 127.0.0.1). The front-end node of the particular distribution device may receive the response message via the localhost. The front-end node may select a back-end node of the particular distribution device or a different distribution device of the distribution PoP based on a hash of the URL, cache key identifier of the response message, and/or identification of the data originator (e.g., an IP address and user agent combination). The front-end node may route the response message to the selected back-end node in the same distribution PoP. The front-end node will have earlier routed the HTTP GET publish message to the same selected back-end node with the HTTP GET publish message resulting in a cache miss and causing the selected back-end node to enter a retrieval mode/state that is associated with retrieval of the data requested via the HTTP GET publish message. The selected back-end node receives the response message (e.g., HTTP RESPONSE message) generated (at 540) and issued (at 550) by the reflector. The response message contains the data that is responsive to the request from the HTTP GET publish message. Accordingly, the back-end node caches the data from the response message (e.g., the data from the value of the key-value that is extracted from the publish message) to local storage (e.g., the key-value store). The data is identified in cache with the cache key of the response message (e.g., the URL and/or key from the extracted key-value of the publish message). The data is now available for redistribution from the back-end node in response to subsequently arriving requests with a URL, URL and cache key, or other identifier that is persistently routed to the back-end node and that is associated with the cached data.

In some embodiments, the reflector may issue (at 550) the response message to a director of the distribution PoP instead of the front-end node when the director performs the persistent distribution for the distribution PoP. In some other embodiments, the reflector may issue (at 550) the response message directly to the selected back-end node. For example, the reflector may directly issue the response message to the selected back-end node when the selected back-end node is on the particular distribution device on which the reflector executes, and the selected back-end node generates a cache miss upon receiving the publish message. To directly issue the response message to the selected back-end node, the reflector may have an interface or port with which to directly communicate with the back-end node without going through the front-end node.

In response to determining (at 530) that the publish message is not formatted as an HTTP GET message (e.g., an HTTP POST message, an HTTP PUT message, other HTTP message, or other publish message format for Real-Time Messaging Protocol (RTMP), HTTP Live Streaming (HLS), HTTP Dynamic Streaming (HDS), HTTP Smooth Streaming (HSS), and other protocols), additional operations may be performed by the reflector to cause a back-end node to cache the data from the key-value that is extracted from the publish message. The additional operations may be necessary when the distribution devices do not directly respond to publish messages that are not HTTP GET messages, because the distribution devices are configured to cache and serve content in response to HTTP GET requests/messages.

Accordingly, in response to a publish message that is not an HTTP GET message, the reflector may first convert (at 560) the publish message to an HTTP GET message, wherein the HTTP GET message includes the extracted key-value from the publish message. The reflector may provide (at 570) the converted HTTP GET message to the front-end node of the particular distribution device via the localhost. The front-end node may perform a persistent distribution of the converted HTTP GET message to select a back-end node, and issue the converted HTTP GET message to the selected back-end node. The converted HTTP GET message may result in a cache miss at the selected back-end node when the requested content and/or key-value was not previously entered in the selected back-end node cache. The cache miss puts the back-end node in a retrieval mode/state, and prepared the selected back-end node to receive data that is requested by the HTTP GET message (e.g., the date from the value of the extracted key-value).

The reflector may then generate (at 540) the response message as a response to the HTTP GET message. Here again, the reflector may generate the response message as an HTTP RESPONSE that includes the data from the value of the key-value that is extracted from the publish message, and a cache key for identifying and/or requesting the data. The reflector may issue (at 550) the HTTP RESPONSE message to the front-end node of the particular distribution device via the localhost. The front-end node may again perform a persistent distribution of the HTTP RESPONSE message to the same back-end node that was selected to receive the converted HTTP GET message, as a result of the HTTP RESPONSE message and the converted HTTP GET message specifying the same identifier (e.g., URL, cache key, other value, or combinations thereof). The back-end node may identify the HTTP RESPONSE message as a response to the converted HTTP GET message, and may cache the data from the HTTP RESPONSE message in local storage (e.g., key-value store) as a result.

It should be noted that operations 510-570 may be performed locally on the distributed device by the reflector without any external network hop traversals. Delays associated with intra-PoP traversals are minimal and insignificant. In many cases, there may be no network hop traversals when the front-end node and selected back-end node execute on the same distribution device as the reflector. There is therefore little or insignificant latency associated with performing operations 510-570, and the resulting entry of the data from the publish message key-value into the particular distribution device local storage or key-value store.

The reflector may also generate (at 580), based on the publish message, a second message for forwarding the publish message or data from the publish message to at least one origin PoP. The reflector may generate the second message by converting the publish message to an HTTP POST message that includes data from the extracted key-value. The reflector may issue (at 590) the second message to the at least one origin PoP of the delivery platform. In response to receiving the second message, the origin PoP caches a copy of the data from the key-value of the publish message, thereby making the data available to distribution devices of other distribution PoPs of the delivery platform. In some embodiments, the reflector may generate (at 580) the second message or HTTP POST message when the publish message is in a different message format (e.g., an HTTP GET message), and may simply pass through the publish message without generating the second message when the publish message is an HTTP POST message or in the correct format.

Although not shown as part of process 500, the reflector or the particular distribution device, on which the reflector executes, may also initiate the identified peer cache fill operation of FIG. 3 in response to issuing (at 550) the response message. The reflector or the selected back-end node may alternatively announce to other distribution devices or other distribution PoPs that the data is now cached in the key-value store of the selected back-end node. The other distribution devices can initiate the peer cache fill operation on their own in response to the announcement.

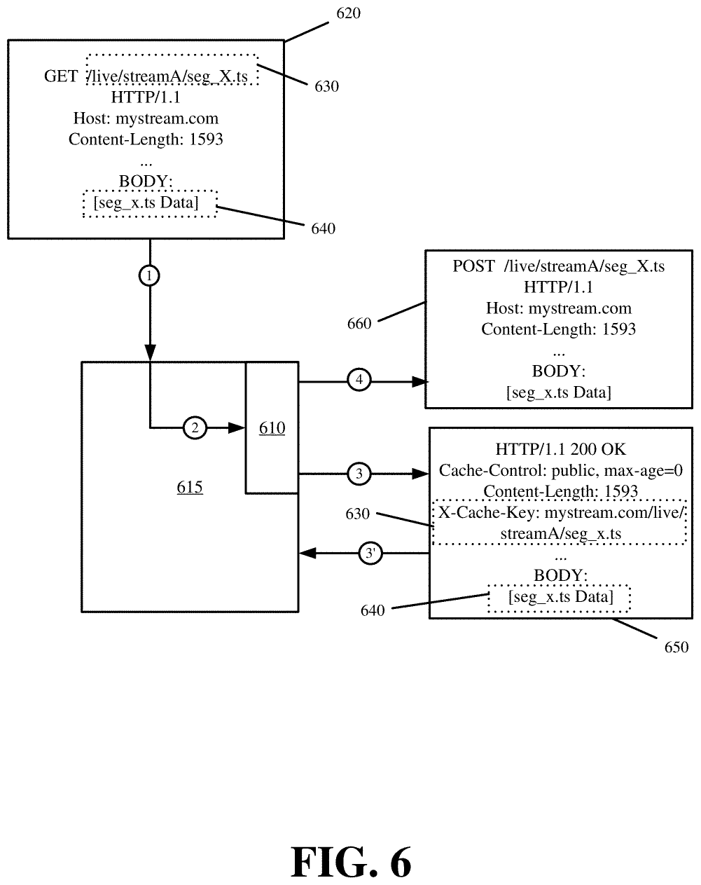

FIG. 6 illustrates an example of the message generation performed by reflector 610 executing on distribution device 615 in accordance with some embodiments. FIG. 6 illustrates distribution device 615 receiving (at 1) HTTP GET publish message 620 containing a key-value for publishing stream segment data. Key 630 of the key-value identifies a cache key, and value 640 of the key-value specifies data that can be accessed via the cache key.

HTTP GET publish message 620 results in a cache miss at distribution device 615 because the data specified in the message URL is not cached by distribution device 615 (e.g., the data is included in the body of the message). In response to the cache miss, distribution device 615 may enter a retrieval state/mode, and may forward the message to an origin PoP. The forwarded message is received (at 2) or intercepted by reflector 610.

Reflector 615 may generate (at 3) HTTP RESPONSE message 650 based on publish message 620. Reflector 615 may issue (at 3′) HTTP RESPONSE message 650 to the front-end node of distribution device 615 via the localhost. HTTP RESPONSE message 650 may include key 630 in conjunction with the data for value 640 that is associated with key 630. The front-end node determines, based on key 630 and value 640 in HTTP RESPONSE message 650, that the message provides the data that was previously requested by HTTP GET message 620, and therefore routes HTTP RESPONSE message 650 to the same back-end node on distribution device 615 that received HTTP GET message 620.

Reflector 610 may also convert (at 4) HTTP GET publish message 620 to a proxy HTTP POST message 660, and may send proxy POST message 660, instead of HTTP GET publish message 620, to the origin PoP of the delivery platform. Reflector 610 may generate and send proxy HTTP POST message 660, instead of HTTP GET publish message 620, so that the origin PoP stores the key-value data and does not generate its own cache miss. In some embodiments, reflector 610 may simply forward the HTTP GET publish message 620, instead of HTTP POST message 660, when the origin PoP is configured to store key-value data from such messages. Similarly, if distribution device 615 receives an HTTP POST publish message, reflector 610 may generate and provide HTTP RESPONSE message 650 to distribution device 615, and may forward the HTTP POST publish message to the origin PoP without conversion.

The distributed key-value store can be used for other applications besides low latency video streaming. For example, a data originator may identify a particular image or web page that will be frequently requested once it is publicly accessible. The data originator may use the distributed key-value store to prepopulate the distributed caches of the delivery platform with the particular image or web page before it is publicly accessible. Accordingly, when the particular image or web page is publicly accessible, the distribution devices of the delivery platform can immediately respond to the incoming requests from cache without cache misses or delays associated with retrieving the particular image or webpage from an origin PoP or other source via one or more network hop traversals.

The distributed key-value store may be used by the delivery platform to improve internal services or functionalities. The delivery platform may leverage the distributed key-value store to avoid renegotiating security and/or encryption parameters for a previously established secure connection with a client device. In particular, a distribution device may store the security and/or encryption parameters and a session identifier or session ticket associated with an established secure connection in its key-value store. The secure connection between the client device and a first distribution device may be terminated, and the client device may return and request an abbreviated handshake for resuming the secure connection with the same security and/or encryption parameters. The abbreviated handshake request may include the session identifier or session ticket. The client device may submit the request to a different second distribution device. The second distribution device may obtain the security and/or encryption parameters associated with the session identifier or session ticket and the client device from the key-value store, and may resume the secure connection with the client device based on the previously negotiated security and/or encryption parameters obtained from the key-value store.

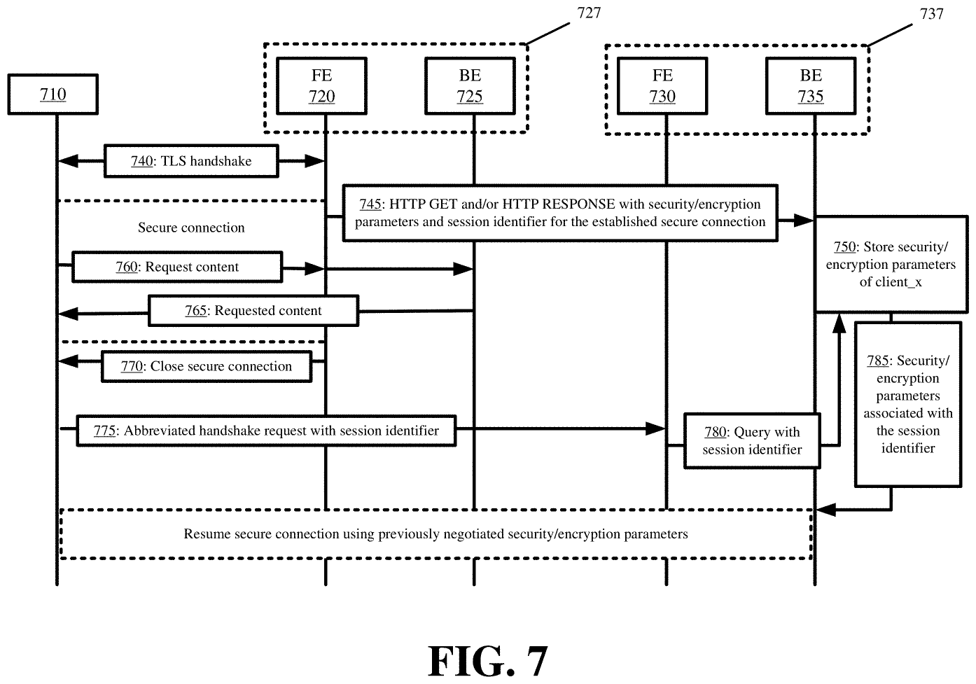

FIG. 7 illustrates an example of storing security and/or encryption parameters that were negotiated when establishing a secure connection between client device 710 and first distribution device 727 in a key-value store, and reusing the security and/or encryption parameters from the key-value store for a secure connection between client device 710 and second distribution device 737 without reestablishing the secure connection, or renegotiating the security and/or encryption parameters for the secure connection. The figure illustrates client device 710, front-end node 720 and back-end node 725 of first distribution device 727, and front-end node 730 and back-end node 735 of second distribution device 737. The first and second distribution devices 727 and 737 represent devices operating in the same distribution PoP of the same delivery platform.

Client device 710 performs a secure connection handshake with front-end node 720. For example, client device 710 performs a TLS or Secure Sockets Layer (SSL) secure connection handshake (at 740) with front-end node 720. During the handshake and multiple round-trip messages exchanged during the handshake, front-end node 720 and client device 710 negotiate security and/or encryption parameters for a secure connection and a session identifier to identify the secure connection. The secure connection is then established allowing for secure and encrypted communications between client device 710 and front-end node 720.

The reflector, executing in conjunction with front-end node 720, may initiate storage of one or more key-values for the security and/or encryption parameters in the key-value store. In some embodiments, a key of a key-value may identify client device 710 (e.g., via an IP address, port number, user agent, header signature, other parameters, or some combination thereof) and a particular security and/or encryption parameter that was negotiated for the secure connection to client device 710. In some embodiments, a key of a key-value may identify the session identifier of the secure connection and a particular security and/or encryption parameter. The value for the key-value may provide the data or value negotiated for the corresponding parameter identified by the key. The reflector may extract the key-values from the handshake messaging, and may generate a publish message (e.g., GET, POST, PUT, etc.), and/or response message (e.g., HTTP RESPONSE message) to enter the key-values in the distributed key-value store. The reflector may pass the generated message(s) to front-end node 720. In some embodiments, the reflector may generate the publish message and/or the response message with a URL that uniquely identifies client device 710 based on an IP address and user agent combination, and/or the session identifier for the secure connection.

Front-end node 720 may hash the URL, client device 710 identifier, session identifier, and/or key from the key-value in the messages provided by the reflector, and may select back-end node 735 based on the hash results. Front-end may provide (at 745) the messages for storing the key-values to back-end node 735, and back-end node 735 may enter (at 750) the key-values in its key-value store.

Client device 710 may securely communicate with front-end node 710 over the secure connection. For instance, client device 710 may issue (at 760) one or more requests for content, and front-end node 720 may determine the requested content is distributed by back-end node 725. Front-end node 720 may forward the requests to back-end node 725, and back-end node 725 may provide (at 765) the requested content over the established secure connection (via front-end node 720).

Front-end node 720 may close (at 770) or terminate the secure connection. Front-end node 720 may close the secure connection after a certain number of requests, a certain amount of time, or client device 710 navigating to a different site or requesting content from a different platform.

After the secure connection is closed, client device 710 may return and request (at 775) an abbreviated handshake to reuse the security and/or encryption parameters from the previous secure connection in order to secure and encrypt communications. The abbreviated handshake request message may be a “Client Hello” message that includes the session identifier associated with the secure connection that was previously established between client device 710 and front-end node 720. The abbreviated handshake request may be routed to front-end node 730. Front-end node 730 attempts to retrieve the previously negotiated security and/or encryption parameters for the secure connection identified by the session identifier from the key-value store. Front-end node 730 may identify the key-value store of the back-end node (e.g., nodes 725 or 735) that stores the parameter based on a hash of a unique identifier of client device 710 (e.g., IP address and user agent combination) and/or the session identifier for the previously negotiated secure connection. In this case, front-end node 730 identifies and queries (at 780) the key-value store of back-end node 735 for the security and/or encryption parameters that were previously negotiated for the secure connection with client device 710. The query may include multiple keys or multiple messages for requesting different security and/or encryption parameters. The query may also include the unique identifier for client device 710 and/or session identifier associated with the previous secure connection.

In response to the query (at 780), back-end node 735 may retrieve and provide (at 785) the security and/or parameters associated with the session identifier for the previously established secure connection from the key-value store to front-end node 730. Front-end node 730 may then notify client device 710 that is has the previously negotiated security and/or encryption parameters. For instance, front-end node 730 may provide client device 710 with a message that includes the same session identifier as provided by client device 710 in the abbreviated handshake request. The previously established secure connection can then be resumed between client device 710 and front-end node 730 using the previous parameters without renegotiation and without the full handshake procedure.

Server, computer, device, and computing machine are meant in their broadest sense, and can include any electronic device with a processor including cellular telephones, smartphones, portable digital assistants, tablet devices, laptops, notebooks, and desktop computers. Examples of computer-readable media include, but are not limited to, CD-ROMs, flash drives, RAM chips, hard drives, EPROMs, etc.

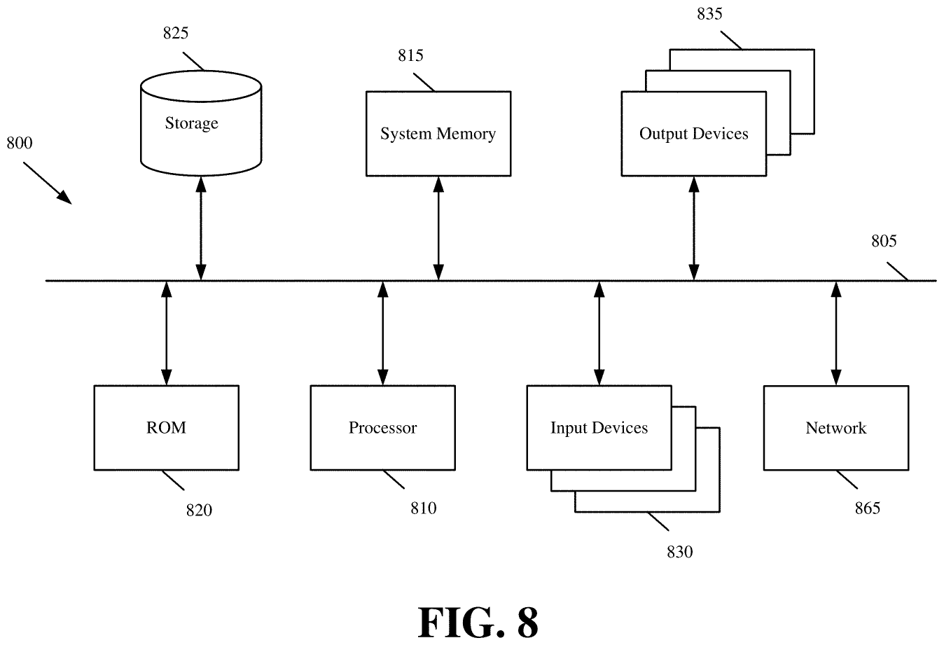

FIG. 8 illustrates a computer system or server with which some embodiments are implemented. Such a computer system includes various types of computer-readable mediums and interfaces for various other types of computer-readable mediums that implement the various methods and machines described above (e.g., load balancer, object distribution server, front-end node, back-end node, etc.). Computer system 800 includes a bus 805, a processor 810, a system memory 815, a read-only memory 820, a permanent storage device 825, input devices 830, and output devices 835.

The bus 805 collectively represents all system, peripheral, and chipset buses that communicatively connect the numerous internal devices of the computer system 800. For instance, the bus 805 communicatively connects the processor 810 with the read-only memory 820, the system memory 815, and the permanent storage device 825. From these various memory units, the processor 810 retrieves instructions to execute and data to process in order to execute the processes of the invention. The processor 810 is a processing device such as a central processing unit, integrated circuit, graphical processing unit, etc.

The read-only-memory (ROM) 820 stores static data and instructions that are needed by the processor 810 and other modules of the computer system. The permanent storage device 825, on the other hand, is a read-and-write memory device. This device is a non-volatile memory unit that stores instructions and data even when the computer system 800 is off. Some embodiments of the invention use a mass-storage device (such as a magnetic or optical disk and its corresponding disk drive) as the permanent storage device 825.

Other embodiments use a removable storage device (such as a flash drive) as the permanent storage device Like the permanent storage device 825, the system memory 815 is a read-and-write memory device. However, unlike storage device 825, the system memory is a volatile read-and-write memory, such as random access memory (RAM). The system memory stores some of the instructions and data that the processor needs at runtime. In some embodiments, the processes are stored in the system memory 815, the permanent storage device 825, and/or the read-only memory 820.

The bus 805 also connects to the input and output devices 830 and 835. The input devices enable the user to communicate information and select commands to the computer system. The input devices 830 include alphanumeric keypads (including physical keyboards and touchscreen keyboards), pointing devices. The input devices 830 also include audio input devices (e.g., microphones, MIDI musical instruments, etc.). The output devices 835 display images generated by the computer system. The output devices include printers and display devices, such as cathode ray tubes (CRT) or liquid crystal displays (LCD).

Finally, as shown in FIG. 8, bus 805 also couples computer 800 to a network 865 through a network adapter (not shown). In this manner, the computer can be a part of a network of computers (such as a local area network (“LAN”), a wide area network (“WAN”), or an Intranet, or a network of networks, such as the Internet).

As mentioned above, the computer system 800 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD−RW, DVD+RW, etc.), flash memory (e.g., SD cards, mini-SD cards, micro-SD cards, etc.), magnetic and/or solid state hard drives, ZIP® disks, read-only and recordable blu-ray discs, any other optical or magnetic media, and floppy disks.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. A method comprising:
detecting a publish message, originating from a data originator, arriving over a data network at a device, the publish message comprising a key and a value, the value comprising data to cache in association with the key in a storage of the device, wherein the device caches the data in response to a retrieval operation initiated by the device, and wherein the publish message is initiated by the data originator;
initiating the retrieval operation by issuing a request message with a request directed to the key in response to the publish message;
generating a response message that provides a response to the retrieval operation initiated by the device, wherein the response message comprises the key and the data from the publish message; and
issuing the response message locally on the device without an external network hop traversal.

2. The method of claim 1, wherein the request message is an HyperText Transfer Protocol (HTTP) GET message, and wherein the response message is an HTTP RESPONSE message that is responsive to the HTTP GET message.

3. The method of claim 1 further comprising extracting the key and the value from the publish message.

4. The method of claim 4, wherein generating comprises embedding the value in the response message.

5. The method of claim 1 further comprising determining the publish message to be an HTTP POST message.

6. The method of claim 5, wherein initiating the retrieval operation comprises generating the request message as an HTTP GET message with the key from the publish message, and issuing the HTTP GET message to the device before said issuing of the response message.

7. The method of claim 6, wherein generating the response message comprises generating locally on the device, an HTTP RESPONSE message with the data and the key provided with the HTTP GET message.

8. The method of claim 1, wherein issuing the response message comprises sending the response message to the device via a localhost of the device without an external network hop traversal.

9. The method of claim 1 further comprising caching the data from the response message to the local storage of the device in response to the response message providing the data requested via the request message.

10. The method of claim 1, wherein the publish message and the request message are the same, and wherein the publish message is of a different message type or format than the response message.

11. The method of claim 1, wherein the publish message, the request message, and the response message are each of a different message type or message format.

12. A method comprising
detecting a publish message arriving at a delivery platform over a data network, the delivery platform comprising a plurality of distribution devices, the plurality of distribution device caching and distributing content to client devices, the publish message specifying a key and a value associated with the key to store in memory of a particular distribution device of the delivery platform;
generating within the delivery platform in response to the publish message, a response message comprising the key and the data from the publish message, and wherein the response message provides a response to a request directed to the key;
issuing the response message to the particular distribution device without an external network hop traversal; and
caching the data associated with the key in local storage of the particular distribution device in response to the issuing.

13. The method of claim 12 further comprising routing the response message to the particular distribution device based on a hash of at least the key in the response message.

14. The method of claim 13 further comprising detecting a request message arriving at the delivery platform over the data network, the request message comprising the key without the value.

15. The method of claim 14 further comprising routing the request message to the particular distribution device based on a hash of the key, and distributing the data associated with the key from the local storage of the particular distribution device in response to the request message comprising the key without the value.

16. The method of claim 12 further comprising generating within the delivery platform a request message specifying the request directed to the key in response to receiving the publish message, and initiating a retrieval operation for the data associated with the key at the particular distribution device in response to issuing the request message to the particular distribution device.

17. The method of claim 16 further comprising determining the publish message to be an HTTP POST message, wherein generating the request message comprises the request message as an HTTP GET message with the key from the publish message, and wherein said issuing the request message occurs before said issuing of the response message.

18. The method of claim 17, wherein generating the response message comprises generating an HTTP RESPONSE message with the data and the key provided with the publish message.

19. A device operating in conjunction a particular distribution server of a delivery platform, the device comprising:
a non-transitory computer-readable medium storing a set of processor-executable instructions; and
one or more processors configured to execute the set of processor-executable instructions, wherein executing the set of processor-executable instructions causes the one or more processors to:
detect a publish message comprising a key and data for entry into a key-value store of the particular distribution;
generate a request message based on the publish message, the request message comprising at least the key from the publish message;
enter the particular distribution server in a data retrieval state by issuing the request message to a localhost of the particular distribution server, and by creating a cache miss at the particular distribution server with said issuing of the request message to the localhost;
generate a response message comprising the data associated with the key from the request message;
complete the data retrieval state of the particular distribution server by issuing the response message to the localhost of the particular distribution server, wherein the particular distribution server caches the data in response to said issuing of the request message to the localhost.
